(19) United States
(12) Patent Application Publication
(10) Pub. No.: US 2013/0201935 A1
(43) Pub. Date: Aug. 8, 2013

(54) APPARATUS AND METHOD OF CHANNEL SETUP

(71) Applicant: Qualcomm Incorporated, San Diego, CA (US)

(72) Inventors: Ravindra Manohar Patwardhan, San Diego, CA (US); Rashid Ahmed Akbar Attar, San Diego, CA (US)

(73) Assignee: Qualcomm Incorporated, San Diego, CA (US)

(21) Appl. No.: 13/753,222

(22) Filed: Jan. 29, 2013

Related U.S. Application Data
(60) Provisional application No. 61/594,900, filed on Feb. 3, 2012.

(51) Int. Cl. H04W 72/04

(52) U.S. Cl. CPC H04W 72/04
USPC 370/329

(57) ABSTRACT

Apparatus and methods are described herein for setting up a communication channel. A mobile station may send a message to a base station to setup a traffic channel. In response, the mobile station may receive a single message from the base station including channel assignment parameters and service option configurations. The mobile station may use the information from the single message to establish the traffic channel. Other aspects, embodiments, and features are also claimed and described.

### CLAIM OF PRIORITY UNDER 35 U.S.C. §119

The present Application for Patent claims priority to U.S. Provisional Application No. 61/594,900 entitled “Apparatus and Method for of Channel Setup” filed Feb. 3, 2012, and assigned to the assignee hereof and hereby expressly incorporated by reference herein.

### TECHNICAL FIELD

The technology discussed in this patent application relates generally to wireless communication, and more particularly, to devices, methods, and systems for establishing communication network connections for calls. Embodiments of the present invention improve conventional procedures in a manner that conserves power and enabling positive user experience.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems (e.g., cdma2000 1× (IS-2000)), time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple mobile stations (MS). Each MS communicates with one or more base stations (BS), such as a Node B or other access point, via transmissions on the forward and reverse links. The forward link (or downlink) refers to the communication link from the BSs to the MSs, and the reverse link (or uplink) refers to the communication link from the MSs to the BSs.

In a network operating according to a Code Division Multiple Access 2000 1× Radio Transmission Technology (CDMA2000 1×RTT) standard (also referred to herein as “1× network”), mobile stations and base stations desiring to establish a traffic channel require an exchange of multiple messages for channel setup. The requirement of these multiple messages leads to large call setup times, thereby degrading the user experience.

### BRIEF SUMMARY OF SOME SAMPLE EMBODIMENTS

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect, a method of setting up a communication channel is described herein. The method comprises sending, from a mobile station, a first message to initiate setup of a traffic channel with a base station; receiving a single message including channel assignment parameters and service option configuration parameters from the base station in response to the first message; and establishing the traffic channel using the channel assignment parameters and the service option configuration parameters from the single message.

In another aspect, another method of setting up a communication channel is described herein. The method comprises receiving, at a base station, a first message to initiate setup of a traffic channel from a mobile station; sending a single message including channel assignment parameters and service option configuration parameters to the mobile station in response to the first message; and establishing the traffic channel using the channel assignment parameters and the service option configuration parameters from the single message.

Other aspects include one or more of: a computer program product having a computer-readable medium including at least one instruction operable to cause a computer to perform the above-described methods; an apparatus including one or more means for performing the above-described methods; and an apparatus having a memory in communication with a processor that is configured to perform the above-described methods.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a schematic diagram of one aspect of a communication system including a mobile station and a base station each configured to perform channel setup according to some embodiments;

FIG. 2 is a schematic diagram of an aspect of a computer device that may embody the mobile station and/or base station of FIG. 1 according to some embodiments;

FIG. 3 is a flow diagram of an aspect of a method of channel setup performed by a mobile station according to some embodiments;

FIG. 4 is a flow diagram of an aspect of a method of channel setup performed by a base station according to some embodiments;

FIG. 5 is a schematic diagram of an aspect of a system for performing channel setup according to some embodiments;

FIG. 6 is a schematic diagram of an aspect of a system for performing channel setup according to some embodiments;

FIG. 7 illustrates a multiple access wireless communication system according to some embodiments; and

FIG. 8 illustrates a block diagram of a communication system according to some embodiments.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Described herein are various aspects related to improving channel setup in a wireless network, such as a network operating according to a Code Division Multiple Access 2000 1× Radio Transmission Technology (CDMA2000 1×RTT) standard (also referred to herein as “1× network”). Rather than requiring multiple messages for channel setup, the described apparatus and methods include sending a single message from the base station to the mobile station in order to initiate channel setup. A used herein, the single message may be referred to as a universal channel assignment message. For example, the single message may include both channel assignment parameters and service option configuration parameters to enable channel setup. In an optional aspect, the mobile station may send the base station a capability indicator to identify that the mobile station supports traffic channel initialization using the single message. Further, in an aspect, the base station may condition the sending of the single message on receiving the capability indicator from the mobile station. Moreover, in another optional aspect, the describe apparatus and methods may include configuring the mobile station to recognize that the base station has acquired a reverse link of the traffic channel based on the mobile station receiving a signaling message from the base station or a frame with a data rate equal to or greater than a ¼ rate from the base station. Thus, the described aspects may reduce channel setup time, and thereby avoiding degradations in an experience of a user of the mobile device when setting up a call.

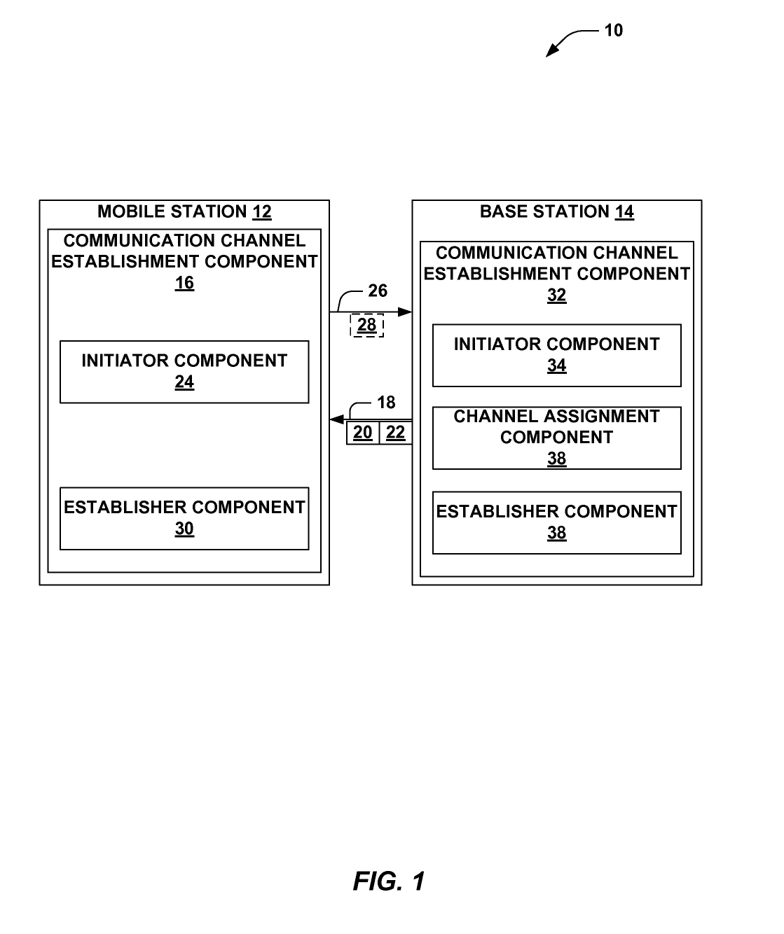

Referring to FIG. 1, a wireless communication system 10 is illustrated that enables improved channel setup between a mobile station 12 and a base station 14. Mobile station 12 can be substantially any type of mobile access terminal, modem (or other tethered device), machine-to-machine (M2M) device, a portion of a relay or other network component, and/or the like, that can register with a base station or wireless network, generate an origination message, or receive and respond to paging signals in a wireless network. Base station 14 can be substantially any type of network access point, such as a macrocell, femtocell, picocell, or similar base station, a mobile base station, a relay, a mobile station communicating in peer-to-peer or ad-hoc mode with mobile station 12, and/or the like, that can communicate channel establishment messages to mobile stations in a wireless network. For example, wireless communication system 10, and/or mobile station 12 and base station 14, may operate according to a Code Division Multiple Access 2000 1× Radio Transmission Technology (CDMA2000 1×RTT) standard.

Mobile station 12 can include a communication channel establishment component 16 that enables mobile device 12 to establish a traffic channel with base station 14 based on a single message 18 received from base station 14. For example, single message 18 includes channel assignment parameters 20 and service option configuration parameters 22. In an aspect, for example, channel assignment parameters 20 may include some or all of the parameters of an Enhanced Channel Assignment Message (ECAM). Also, in an aspect, for example, service option configuration parameters 22 may include some or all of the parameters of Service Connect Message (SCM).

In an aspect, communication channel establishment component 16 may include an initiator component 24 for generating and sending a first message 26 to initiate setup of a traffic channel with base station 14. For example, first message 22 may include, but is not limited to, one of a registration message (RGM), an origination message (ORM), a page response message (PRM), or a general extension message (GEM) message.

In an optional aspect, initiator component 20 may be further configured to generate and send a capability indicator 28 to base station 14. In an aspect, for example, capability indicator 28 identifies that mobile station 12 supports traffic channel initialization using single message 18. Further, in an aspect, capability indicator 28 may be included in first message 26.

Further, in an aspect, communication channel establishment component 16 also may include an establisher component 30 for receiving single message 18 including channel assignment parameters 20 and service option configuration parameters 22 from base station 14 in response to first message 22. Moreover, establisher component 30 is further configured to establish the traffic channel using channel assignment parameters 26 and service option configuration parameters 28. In an aspect, for example, establisher component 30 may perform a traffic channel initialization procedure, which may include acquiring a forward link of the traffic channel and transmitting a preamble to base station 14, and receiving an acknowledgement from base station 14 after acquisition of a reverse link of the traffic channel by base station 14.

Further, mobile station 12 may receive data from base station 14 and/or transmit data to base station 14 upon establishment of the traffic channel.

Base station 14 can include a communication channel establishment component 32 that enables base station 14 to send single message 18 to mobile device 12 to establish a traffic channel.

In an aspect, communication channel establishment component 32 may include an initiator component 34 configured to receive first message 26 from mobile station 12 to initiate setup of a traffic channel. Optionally, initiator component 34 may be further configured to generate and send a page to mobile station 12 to trigger first message 26 to be sent from mobile station 12.

Moreover, in an aspect, communication channel establishment component 32 may include a channel assignment component 36 configured to send single message 18 including channel assignment parameters 20 and service option configuration parameters 22 to mobile station 12 in response to first message 26. In an aspect, channel assignment component 36 may only send single message 18 upon receipt of capability indicator 28 from mobile station 12. For example, capability indicator 28 may be received separate from or included in first message 26.

Further, communication channel establishment component 32 may include a establisher component 38 configured to establish the traffic channel according to channel assignment parameters 20 and the service option configuration parameters 22 defined by single message 18. In an aspect, establisher component 38 may perform a traffic channel initialization procedure, which may include sending data frames over a forward link of the traffic channel to enable mobile station 12 to acquire the forward link, and receiving in response a preamble from mobile station 12. Additionally, the traffic channel initialization procedure may subsequently include acquiring a reverse link of the traffic channel, and sending an acknowledgement to mobile station 12.

Accordingly, upon establishment of the traffic channel, base station 14 may send data to or receive data from mobile station 12.

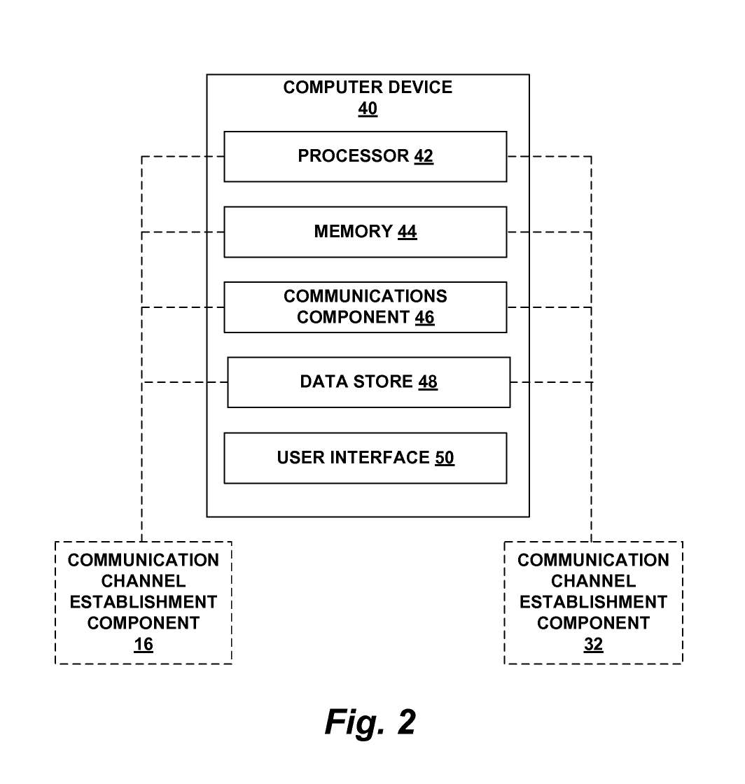

Referring to FIG. 2, in one aspect, any of mobile station 12 or base station 14 (FIG. 1) may be represented by a specially programmed or configured computer device 40. Computer device 40 includes a processor 42 for carrying out processing functions associated with one or more of components and functions described herein. Processor 42 can include a single or multiple set of processors or multi-core processors. Moreover, processor 42 can be implemented as an integrated processing system and/or a distributed processing system.

Computer device 40 further includes a memory 44, such as for storing data used herein and/or local versions of applications being executed by processor 42. Memory 44 can include any type of memory usable by a computer, such as random access memory (RAM), read only memory (ROM), tapes, magnetic discs, optical discs, volatile memory, non-volatile memory, and any combination thereof.

Further, computer device 40 includes a communications component 46 that provides for establishing and maintaining communications with one or more parties utilizing hardware, software, and services as described herein. Communications component 46 may carry communications between components on computer device 40, as well as between computer device 40 and external devices, such as devices located across a communications network and/or devices serially or locally connected to computer device 40. For example, communications component 46 may include one or more buses, and may further include transmit chain components and receive chain components associated with a transmitter and receiver, respectively, or a transceiver, operable for interfacing with external devices.

Additionally, computer device 40 may further include a data store 48, which can be any suitable combination of hardware and/or software, that provides for mass storage of information, databases, and programs employed in connection with aspects described herein. For example, data store 48 may be a data repository for applications not currently being executed by processor 42.

Computer device 40 may additionally include a user interface component 50 operable to receive inputs from a user of computer device 40, and further operable to generate outputs for presentation to the user. User interface component 50 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 50 may include one or more output devices, including but not limited to a display, a speaker, a haptic feedback mechanism, a printer, any other mechanism capable of presenting an output to a user, or any combination thereof.

In a mobile station implementation, such as for mobile station 12 of FIG. 1, computer device 40 may include communication channel establishment component 16, such as in specially programmed computer readable instructions or code, firmware, hardware, or some combination thereof.

In a base station implementation, such as for base station 14 of FIG. 1, computer device 40 may include communication channel establishment component 32, such as in specially programmed computer readable instructions or code, firmware, hardware, or some combination thereof.

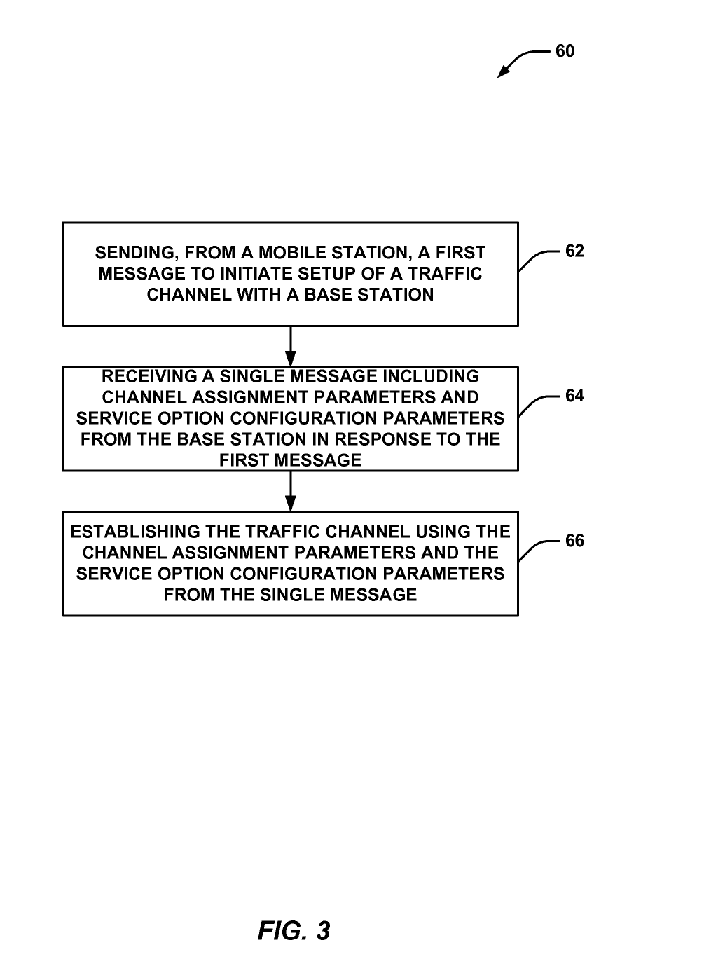

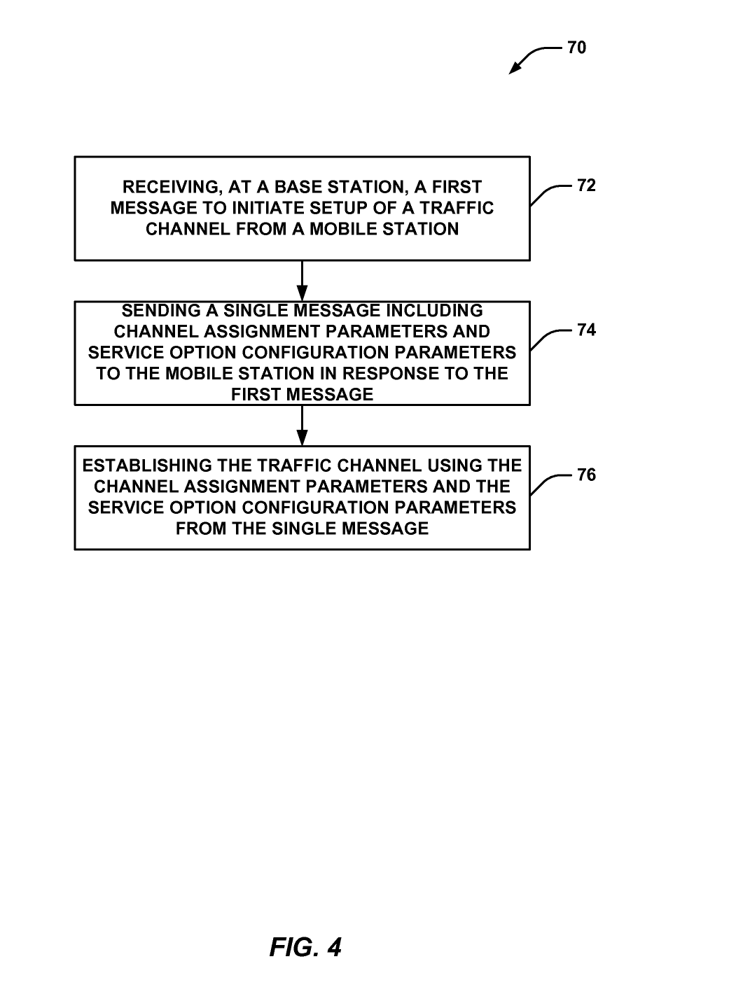

Referring to FIGS. 3 and 4, example methodologies for channel setup are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Referring to FIG. 3, an example method 60 for channel setup performed by a mobile station is illustrated.

At 62, method 60 includes sending, from a mobile station, a first message to initiate setup of a traffic channel with a base station.

At 64, method 60 includes receiving a single message including channel assignment parameters and service option configuration parameters from the base station in response to the first message.

Additionally, at 66, method 60 includes establishing the traffic channel using the channel assignment parameters and the service option configuration parameters from the single message.

In one aspect, for example, the actions of method 60 for channel setup may performed by mobile station 12 (FIG. 1), or components of mobile station 12, as discussed herein.

Turning to FIG. 4, an example methodology 70 for channel setup performed by a base station is illustrated.

At 72, method 70 includes receiving, at a base station, a first message to initiate setup of a traffic channel from a mobile station.

At 74, method 70 includes sending a single message including channel assignment parameters and service option configuration parameters to the mobile station in response to the first message.

Additionally, at 76, method 70 includes establishing the traffic channel using the channel assignment parameters and the service option configuration parameters from the single message.

In one aspect, for example, the actions of method 70 for channel setup may performed by base station 14 (FIG. 1), or components of base station 14, as discussed herein.

It will be appreciated that, in accordance with one or more aspects described herein, inferences can be made regarding channel setup, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

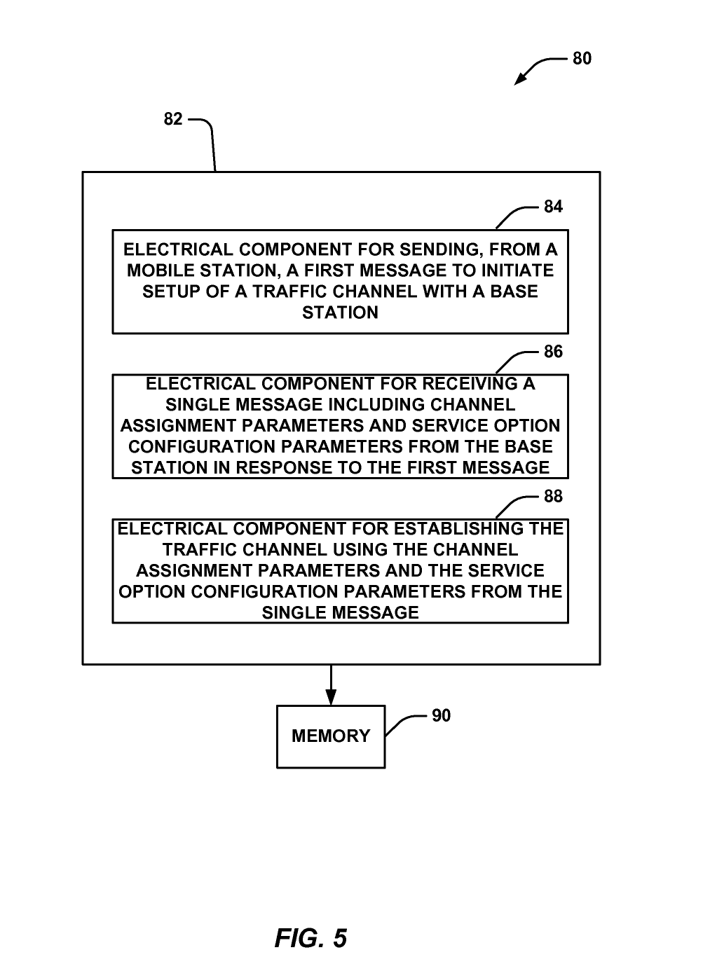

Referring to FIG. 5, an example system 80 for channel setup in a wireless communication system is illustrated. For example, system 80 can reside at least partially within a mobile station, such as mobile station 12 (FIG. 1). It is to be appreciated that system 80 is represented as including functional blocks, which can be functional blocks that represent functions implemented by a processor, software, or combination thereof (e.g., firmware). System 80 includes a logical grouping 82 of electrical components that can act in conjunction. For instance, logical grouping 82 can include an electrical component 84 for sending, from a mobile station, a first message to initiate setup of a traffic channel with a base station.

Moreover, logical grouping 82 can include an electrical component 86 for receiving a single message including channel assignment parameters and service option configuration parameters from the base station in response to the first message.

Logical grouping 82 can also include an electrical component 88 for establishing the traffic channel using the channel assignment parameters and the service option configuration parameters from the single message.

Moreover, in one example, logical grouping 82 of electrical components can comprise communication channel establishment component 16 of FIG. 1.

Additionally, system 80 can include a memory 90 that retains instructions for executing functions associated with the electrical components 84, 86, and 88, stores data used or obtained by the electrical components 84, 506, 88, etc. While shown as being external to memory 80, it is to be understood that one or more of the electrical components 84, 86, and 88 can exist within memory 80. In one example, electrical components 84, 86, and 88 can comprise at least one processor, or each electrical component 84, 86, and 88 can be a corresponding module of at least one processor. Moreover, in an additional or alternative example, electrical components 84, 86, and 88 can be a computer program product including a computer readable medium, where each electrical component 84, 86, and 88 can be corresponding code.

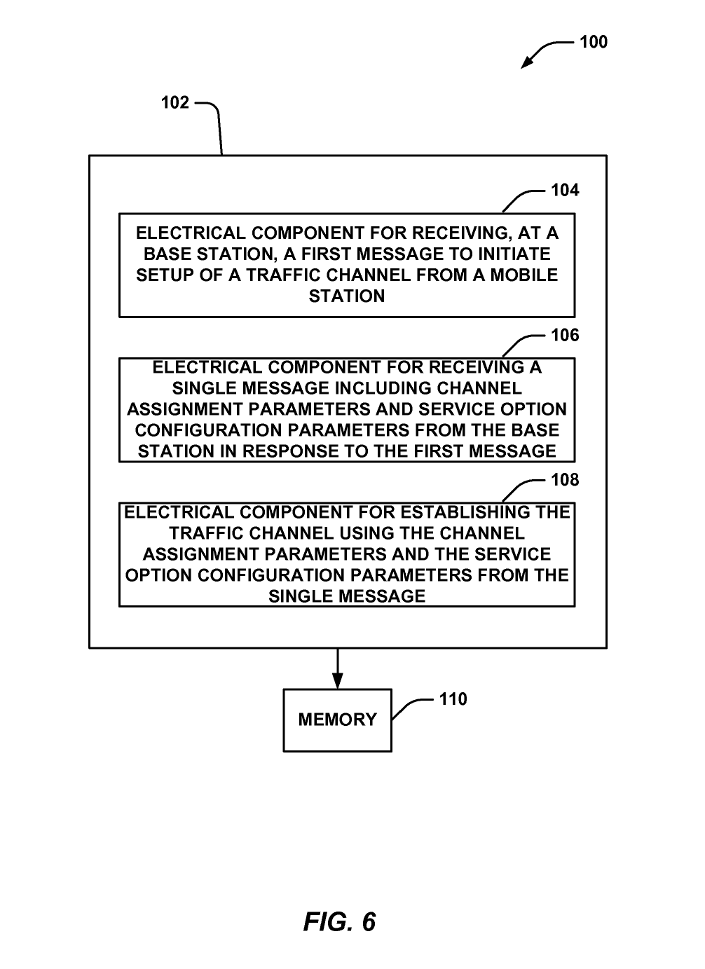

Referring to FIG. 6, an example system 100 for channel setup in a wireless communication system is illustrated. For example, system 100 can reside at least partially within a mobile station, such as mobile station 12 (FIG. 1). It is to be appreciated that system 100 is represented as including functional blocks, which can be functional blocks that represent functions implemented by a processor, software, or combination thereof (e.g., firmware). System 100 includes a logical grouping 102 of electrical components that can act in conjunction. For instance, logical grouping 102 can include an electrical component 104 for includes receiving, at a base station, a first message to initiate setup of a traffic channel from a mobile station.

Moreover, logical grouping 102 can include an electrical component 106 for sending a single message including channel assignment parameters and service option configuration parameters to the mobile station in response to the first message.

Logical grouping 102 can also include an electrical component 108 for establishing the traffic channel using the channel assignment parameters and the service option configuration parameters from the single message.

Moreover, in one example, logical grouping 102 of electrical components can comprise communication channel establishment component 32 of FIG. 1.

Additionally, system 100 can include a memory 110 that retains instructions for executing functions associated with the electrical components 104, 106, and 108, stores data used or obtained by the electrical components 104, 106, 108, etc. While shown as being external to memory 100, it is to be understood that one or more of the electrical components 104, 106, and 108 can exist within memory 110. In one example, electrical components 104, 106, and 108 can comprise at least one processor, or each electrical component 104, 106, and 108 can be a corresponding module of at least one processor. Moreover, in an additional or alternative example, electrical components 104, 106, and 108 can be a computer program product including a computer readable medium, where each electrical component 104, 106, and 108 can be corresponding code.

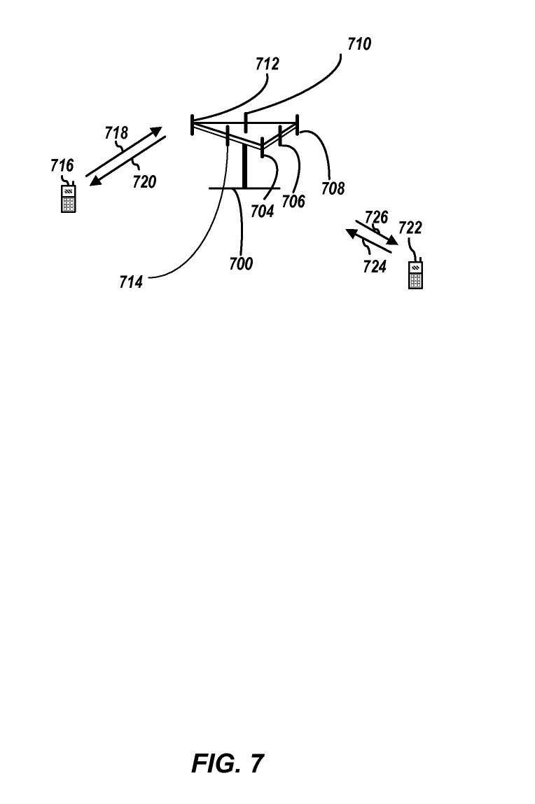

Referring to FIG. 7, a multiple access wireless communication system according to one embodiment is illustrated. An access point 700 (AP) includes multiple antenna groups, one including 704 and 706, another including 708 and 77, and an additional including 712 and 714. In FIG. 7, only two antennas are shown for each antenna group, however, more or fewer antennas can be utilized for each antenna group. Access terminal 716 (AT) is in communication with antennas 712 and 714, where antennas 712 and 714 transmit information to access terminal 716 over forward link 720 and receive information from access terminal 716 over reverse link 718. Access terminal 722 is in communication with antennas 704 and 706, where antennas 704 and 706 transmit information to access terminal 722 over forward link 726 and receive information from access terminal 722 over reverse link 724. In a FDD system, communication links 718, 720, 724 and 726 can use different frequency for communication. For example, forward link 720 can use a different frequency then that used by reverse link 718.

Each group of antennas and/or the area in which they are designed to communicate is often referred to as a sector of the access point. In the embodiment, antenna groups each are designed to communicate to access terminals in a sector of the areas covered by access point 700.

In communication over forward links 720 and 726, the transmitting antennas of access point 700 utilize beamforming in order to improve the signal-to-noise ratio of forward links for the different access terminals 716 and 722. Also, an access point using beamforming to transmit to access terminals scattered randomly through its coverage causes less interference to access terminals in neighboring cells than an access point transmitting through a single antenna to all its access terminals.

Moreover, access terminals 716 and 722 and access point 700 can provide functionality to perform channel setup utilizing single message 18 (FIG. 1), as described above.

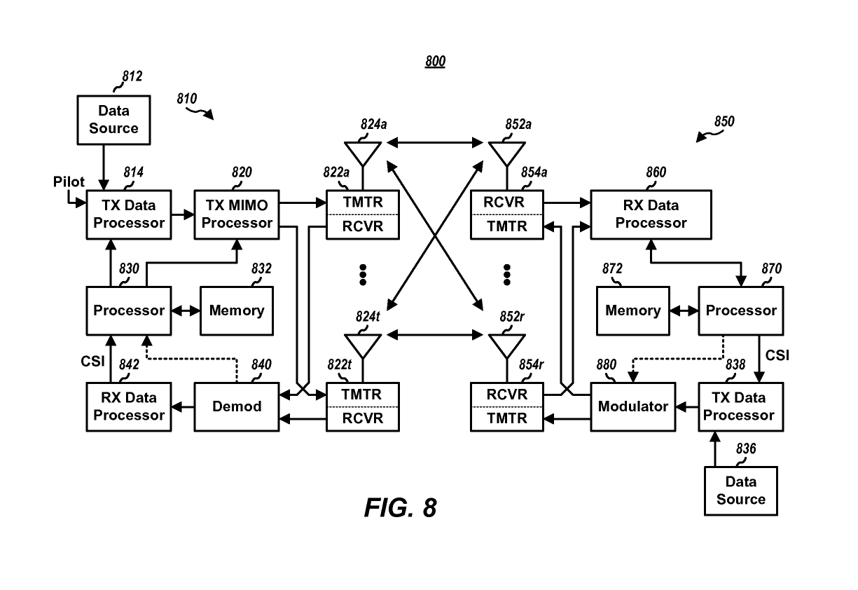

FIG. 8 is a block diagram of an embodiment of a transmitter system 810 (also known as the access point) and a receiver system 850 (also known as access terminal) in a MIMO system 800. At the transmitter system 810, traffic data for a number of data streams is provided from a data source 812 to a transmit (TX) data processor 814. In addition, it is to be appreciated that transmitter system 810 and/or receiver system 850 can employ the systems (FIGS. 1, 2, and 5-7) and/or methods (FIGS. 3 and 4) described herein to facilitate wireless communication there between. For example, components or functions of the systems and/or methods described herein can be part of a memory 832 and/or 872 or processors 830 and/or 870 described below, and/or can be executed by processors 830 and/or 870 to perform the disclosed functions.

In an embodiment, each data stream is transmitted over a respective transmit antenna. TX data processor 814 formats, codes, and interleaves the traffic data for each data stream based on a particular coding scheme selected for that data stream to provide coded data.

The coded data for each data stream can be multiplexed with pilot data using OFDM techniques. The pilot data is typically a known data pattern that is processed in a known manner and can be used at the receiver system to estimate the channel response. The multiplexed pilot and coded data for each data stream is then modulated (e.g., symbol mapped) based on a particular modulation scheme (e.g., BPS K, QSPK, M-PSK, or M-QAM) selected for that data stream to provide modulation symbols. The data rate, coding, and modulation for each data stream can be determined by instructions performed by processor 830.

The modulation symbols for all data streams are then provided to a TX MIMO processor 820, which can further process the modulation symbols (e.g., for OFDM). TX MIMO processor 820 then provides N_{T} modulation symbol streams to N_{T} transmitters (TMTR) 822a through 822t. In certain embodiments, TX MIMO processor 820 applies beamforming weights to the symbols of the data streams and to the antenna from which the symbol is being transmitted.

Each transmitter 822 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 822a through 822t are then transmitted from N_{T} antennas 824a through 824t, respectively.

At receiver system 850, the transmitted modulated signals are received by N_{R} antennas 852a through 852r and the received signal from each antenna 852 is provided to a respective receiver (RCVR) 854a through 854r. Each receiver 854 conditions (e.g., filters, amplifies, and downconverts) a respective received signal, digitizes the conditioned signal to provide samples, and further processes the samples to provide a corresponding “received” symbol stream.

An RX data processor 860 then receives and processes the N_{R} received symbol streams from N_{R} receivers 854 based on a particular receiver processing technique to provide N_{T} “detected” symbol streams. The RX data processor 860 then demodulates, deinterleaves, and decodes each detected symbol stream to recover the traffic data for the data stream. The processing by RX data processor 860 is complementary to that performed by TX MIMO processor 820 and TX data processor 814 at transmitter system 810.

A processor 870 periodically determines which pre-coding matrix to use. Processor 870 formulates a reverse link message comprising a matrix index portion and a rank value portion.

The reverse link message can comprise various types of information regarding the communication link and/or the received data stream. The reverse link message is then processed by a TX data processor 838, which also receives traffic data for a number of data streams from a data source 836, modulated by a modulator 880, conditioned by transmitters 854a through 854r, and transmitted back to transmitter system 810.

At transmitter system 810, the modulated signals from receiver system 850 are received by antennas 824, conditioned by receivers 822, demodulated by a demodulator 840, and processed by a RX data processor 842 to extract the reserve link message transmitted by the receiver system 850. Processor 830 then determines which pre-coding matrix to use for determining the beamforming weights then processes the extracted message.

Processors 830 and 870 can direct (e.g., control, coordinate, manage, etc.) operation at transmitter system 810 and receiver system 850, respectively. Respective processors 830 and 870 can be associated with memory 832 and 872 that store program codes and data. For example, processors 830 and 870 can perform functions described herein with respect to channel setup using single message 18 (FIG. 1). Similarly, memory 832 and 872 can store instructions for executing the functionality or components, and/or related data.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Furthermore, various aspects may have been described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, user equipment, or user equipment device. A wireless terminal can be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station can be utilized for communicating with wireless terminal(s) and can also be referred to as an access point, access node, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features may have been presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of setup of a communication channel, comprising:
sending, from a mobile station, a first message to initiate setup of a traffic channel with a base station;
receiving a single message including channel assignment parameters and service option configuration parameters from the base station in response to the first message; and
establishing the traffic channel using the channel assignment parameters and the service option configuration parameters from the single message.

2. The method of claim 1, further comprising sending a capability indicator to the base station prior to receiving the single message, wherein the capability indicator identifies that the mobile station supports traffic channel initialization using the single message.

3. The method of claim 2, further comprising including the capability indicator in the first message.

4. The method of claims 2, wherein receiving the single message is further in response to the base station receiving the capability indicator.

5. The method of claim 1, wherein sending the first message further comprises sending one of a registration message (RGM), an origination message (ORM), a page response message (PRM), or a general extension message (GEM) message.

6. The method of claim 1, wherein receiving the single message includes receiving a universal channel assignment message.

7. The method of claim 1, wherein establishing the traffic channel further comprises acquiring a forward link of the traffic channel, and transmitting a preamble on a reverse pilot channel (R-PICH).

8. The method of claim 7, further comprising receiving data on the forward link of the traffic channel.

9. The method of claim 1, wherein establishing the traffic channel further comprises determining that the base station has acquired a reverse link of the traffic channel based on receiving a signaling message from the base station or receiving a frame with a data rate equal to or greater than a ¼ rate from the base station.

10. The method of claim 9, further comprising transmitting data on the reverse link of the traffic channel.

11. The method of claim 1, further comprising performing the sending, the receiving, and the establishing according to a code division multiple access 2000 1× radio transmission technology (CDMA2000 1×RTT) standard.

12. A computer program product for setup of a communication channel, comprising:
a computer-readable medium, comprising:
code for causing at least one computer to send, from a mobile station, a first message to initiate setup of a traffic channel with a base station;
code for causing the at least one computer to receive a single message including channel assignment parameters and service option configuration parameters from the base station in response to the first message; and
code for causing the at least one computer to establish the traffic channel using the channel assignment parameters and the service option configuration parameters from the single message.

13. A mobile station apparatus for setup of a communication channel, comprising:
means for sending, from a mobile station, a first message to initiate setup of a traffic channel with a base station;
means for receiving a single message including channel assignment parameters and service option configuration parameters from the base station in response to the first message; and
means for establishing the traffic channel using the channel assignment parameters and the service option configuration parameters from the single message.

14. A mobile station, comprising:
at least one processor configured to:
send, from a mobile station, a first message to initiate setup of a traffic channel with a base station;
receive a single message including channel assignment parameters and service option configuration parameters from the base station in response to the first message; and
establish the traffic channel using the channel assignment parameters and the service option configuration parameters from the single message; and
a memory coupled to the at least one processor.

15. The mobile station of claim 14, wherein the at least one processor is further configured to send a capability indicator to the base station prior to receiving the single message, wherein the capability indicator identifies that the mobile station supports traffic channel initialization using the single message.

16. The mobile station of claim 15, wherein the at least one processor is further configured to include the capability indicator in the first message.

17. The mobile station of claims 15, wherein receiving the single message is further in response to the base station receiving the capability indicator.

18. The mobile station of claim 14, wherein the at least one processor is further configured to send the first message further by sending one of a registration message (RGM), an origination message (ORM), a page response message (PRM), or a general extension message (GEM) message.

19. The mobile station of claim 14, wherein receiving the single message includes receiving a universal channel assignment message.

20. The mobile station of claim 14, wherein in establishing the traffic channel, the at least one processor is further configured to acquire a forward link of the traffic channel, and transmitting a preamble on a reverse pilot channel (R-PICH).

21. The mobile station of claim 20, wherein the at least one processor is further configured to receive data on the forward link of the traffic channel.

22. The mobile station of claim 14, wherein in establishing the traffic channel, the at least one processor is further configured to determine that the base station has acquired a reverse link of the traffic channel based on receiving a signaling message from the base station or receiving a frame with a data rate equal to or greater than a ¼ rate from the base station.

23. The mobile station of claim 22, wherein the at least one processor is further configured to transmit data on the reverse link of the traffic channel.

24. The mobile station of claim 14, wherein the at least one processor is further configured to perform the sending, the receiving, and the establishing according to a code division multiple access 2000 1× radio transmission technology (CDMA2000 1×RTT) standard.

25. A method of setup of a communication channel, comprising:
receiving, at a base station, a first message to initiate setup of a traffic channel from a mobile station;
sending a single message including channel assignment parameters and service option configuration parameters to the mobile station in response to the first message; and
establishing the traffic channel using the channel assignment parameters and the service option configuration parameters from the single message.

26. The method of claim 25, further comprising receiving a capability indicator from the mobile station prior to sending the single message, wherein the capability indicator identifies that the mobile station supports traffic channel initialization using the single message.

27. The method of claim 26, wherein receiving the capability indicator further comprises receiving in the first message.

28. The method of claim 26, wherein sending the single message is further in response to the receiving of the capability indicator.

29. The method of claim 25, wherein receiving the first message further comprises receiving one of a registration message (RGM), an origination message (ORM), a page response message (PRM), or a general extension message (GEM) message.

30. The method of claim 25, wherein sending the single message includes sending a universal channel assignment message.

31. The method of claim 25, wherein establishing the traffic channel further comprises:
sending data frames over a forward link to the mobile station;
receiving a preamble on a reverse pilot channel (R-PICH) in response to the mobile station receiving the data frames; and
acquiring a reverse link.

32. The method of claim 25 wherein establishing the traffic channel further comprises sending a signaling message or a frame with a data rate equal to or greater than a ¼ rate to the mobile station to signal acquiring of a reverse link of the traffic channel.

33. The method of claim 32, further comprising transmitting data on the reverse link of the traffic channel.

34. The method of claim 25, further comprising performing the receiving, the sending, and the establishing according to a code division multiple access 2000 1× radio transmission technology (CDMA2000 1×RTT) standard.

35. A computer program product for setup of a communication channel, comprising:
a computer-readable medium, comprising:
code for causing at least one computer to receive, at a base station, a first message to initiate setup of a traffic channel from a mobile station;
code for causing the at least one computer to send a single message including channel assignment parameters and service option configuration parameters to the mobile station in response to the first message; and
code for causing the at least one computer to establish the traffic channel using the channel assignment parameters and the service option configuration parameters from the single message.

36. An apparatus for setup of a communication channel, comprising:
means for receiving, at a base station, a first message to initiate setup of a traffic channel from a mobile station;
means for sending a single message including channel assignment parameters and service option configuration parameters to the mobile station in response to the first message; and
means for establishing the traffic channel using the channel assignment parameters and the service option configuration parameters from the single message

37. A base station apparatus for setup of a communication channel, comprising:
at least one processor configured to:
receive a first message to initiate setup of a traffic channel from a mobile station;
send a single message including channel assignment parameters and service option configuration parameters to the mobile station in response to the first message; and
establish the traffic channel using the channel assignment parameters and the service option configuration parameters from the single message; and
a memory coupled to the at least one processor.

38. The base station apparatus of claim 37, wherein the at least one processor is further configured to receive a capability indicator from the mobile station prior to sending the single message, wherein the capability indicator identifies that the mobile station supports traffic channel initialization using the single message.

39. The base station apparatus of claim 38, wherein receiving the capability indicator further comprises receiving in the first message.

40. The base station apparatus of claim 38, wherein sending the single message is further in response to the receiving of the capability indicator.

41. The base station apparatus of claim 37, wherein the at least one processor is further configured to receive the first message further comprising receiving one of a registration message (RGM), an origination message (ORM), a page response message (PRM), or a general extension message (GEM) message.

42. The base station apparatus of claim 37, wherein sending the single message includes sending a universal channel assignment message.

43. The base station apparatus of claim 37, wherein in establishing the traffic channel, the at least one processor is further configured to:
send data frames over a forward link to the mobile station;
receive a preamble on a reverse pilot channel (R-PICH) in response to the mobile station receiving the data frames; and
acquire a reverse link.

44. The base station apparatus of claim 37 wherein in establishing the traffic channel, the at least one processor is further configured to send a signaling message or a frame with a data rate equal to or greater than a ¼ rate to the mobile station to signal acquiring of a reverse link of the traffic channel.

45. The base station apparatus of claim 44, wherein the at least one processor is further configured to transmit data on the reverse link of the traffic channel.

46. The base station apparatus of claim 37, wherein the at least one processor is further configured to peform the receiving, the sending, and the establishing according to a code division multiple access 2000 1× radio transmission technology (CDMA2000 1×RTT) standard.
